(19) United States
(12) Patent Application Publication
(10) Pub. No.: US 2017/0017696 A1
(43) Pub. Date: Jan. 19, 2017

(54) SEMANTIC OBJECT TAGGING THROUGH NAME ANNOTATION

(71) Applicant: Microsoft Technology Licensing, LLC, Redmond, WA (US)

(72) Inventor: Omar Alonso, Redwood Shores, CA (US)

(21) Appl. No.: 14/798,778

(22) Filed: Jul. 14, 2015

(51) Int. Cl. G06F 17/30; G06F 3/0484; G06F 17/24

(52) U.S. Cl. CPC G06F 17/30525; G06F 17/241; G06F 3/0484

(57) ABSTRACT

Objects in an object system may be identified by names, and a user may query the object system by specifying a set of keywords that are compared with the names to provide matching objects as search results. However, keyword ambiguity in both the query and the object names may cause query results that include objects using the keyword in a different context than the intent of the query. Presented herein are techniques for identifying objects using annotated names, where various entity values that are present in the object name are tagged with an entity type. The entity tags may be hidden when presenting the object name to a user, and may be utilized to index objects according by entity values and corresponding entity types. Queries may be fulfilled through comparison of the query with entity type and entity value pairs present in the annotated names of the objects.

### BACKGROUND

Within the field of computing, many scenarios involve an object set featuring a set of objects respectively identified by a name and/or location, such as a hierarchical file system featuring a set of files organized into folders, and a media database featuring a set of media objects identified by a descriptive name.

In such scenarios, the user may name and organize the objects in ways that reflect the semantics and relationships of the objects, and may later utilize such naming and organization to locate objects of interest. As a first such example, contextually related objects may be organized using a grouping mechanism, such as by placing related objects of an object system within the same folder, and the user may later find the set of related objects by browsing for and finding the enclosing folder. As a second such example, the user may wish to locate a particular set of objects, and may do so by submitting a name query, such as a set of keywords that likely appear in the name of the objects of interest. A device may examine the object set to identify matching objects, optionally with the assistance of an index such as a hashtable, and may present to the user the objects that match the name query submitted by the user. As a third such example, the user may utilize a database that allows the user to attach semantic tags to objects, such as explicitly tagging photos in a photo set according to the people and subjects represented in each photo, and may later search for images that have been tagged with a particular tag.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A device that allows a user to search for objects according to name queries may encounter a host of problems that cause the results of the query not to match the expectations of the user.

As a first such example, the user may semantically sort the objects into a hierarchical object set (such as a file system) where the location of the object denotes its semantics. However, many such object sets allow objects to exist only in one location at a time. If an object that pertains to two groups that exist in two separate locations, the user may have to choose one location, and may later fail to find the object as expected by browsing in the other location. For example, the user may have a first folder for photos, and a second photo for project documents, and may have difficulty determining where to place a photo that is associated with a project. Moreover, if the user later moves the object from one location to another the semantics associated with the location may be lost. For example, if a user copies an object of an object system to portable media but does not include the encapsulating folders, the semantic identity of the object conferred by its original folder may be lost, as well as the association of the object with the other objects in the original folder.

As a second such example, the user may submit keyword searches to find an object, and such keywords may be compared with the contents and metadata describing each object. However, such keywords may inaccurately describe the respective objects without due context. For example, the user of a photo library may wish to find a set of images about an individual named Catherine (sometimes known as Cat), and may therefore search the library for the keyword “cat.” However, the photo library may contain a large number of unrelated images with the keyword “cat,” such as images of cats; images of flowers known as cattails; and medical images that include computer-assisted tomography (“CAT”) scans. The difficulty arising in such circumstances is that the user is unable to specify that the word “cat” reflects the name of a person, and the object set is unable to distinguish which object names that feature the word “cat” do so in relation to a person, as compared with any other context.

As a third such example, a database tagging system may permit the user to indicate the semantic topics of objects in an object set, and may do so without relation to the name of the object. For example, an image named “IMG_1001.JPG” or “Trip Photos/Beach.jpg” may be tagged to identify the individuals depicted in the image. However, such schemes typically depend upon the user's explicit and affirmative tagging of the images, possibly in addition to (and distinct from) the user's naming of the images. Such duplicate effort may be inefficient and onerous (e.g., the user may have to name the object as “At the Beach with Sue and Mark,” and may then have to tag the object in the database with the tags “beach,” “Sue,” and “Mark”), as well as prone to errors (e.g., an image may be named “Sue and Mark,” but may be semantically tagged to indicate that the photo is an image of Sue, David, and Lisa). Searches may therefore provide incorrect and confusing results, such as returning a different set of objects for a keyword-based name query than for a tag-based query utilizing the same keywords. Moreover, if the objects are separated from the database, such as by copying to portable media, or if the objects are accessed in a manner that does not utilize the database (e.g., browsing or searching within a file system rather than specifically within the database describing the files contained therein), the semantics of the object that are stored in the database may be completely lost.

As a fourth such example, the metadata that may describe the objects of the object set may be voluminous. Organizational techniques that rely upon the user to specify all of the details of the metadata may be difficult to manage, particularly as the complexity of the object set and the number of objects grows. When the user does not completely or consistently annotate the objects, an object location system may fail to find untagged objects, or may present inconsistent results in response to a user query, such as presenting some objects that have been tagged in relation to a queried topic, while failing to present other objects that also relate to the queried topic but have not been tagged by the user.

Presented herein are techniques that enable the determination of the semantic associations of named objects of an object set. In this example scenario, a device may examine a name of an object to identify an entity value for an entity type. For example, an object representing a book may have an object name that includes the title of the book (where the title of the book is the entity value for the “title” entity type), and/or the author (i.e., the name of the author is the entity value for the “author” entity type). The name of the object may be annotated with tags to denote the entity types of the entity values present in the name. For example, if an object is received with the name “Modern Physics—Relativity Lecture Notes.docx,” the name and various sources of information (e.g., the object contents, location, and usage pattern of the object) may be examined to determine that the name contains entity values for three types of entities: the name of a class to which the object pertains (“Modern Physics”); the name of a topic covered in the class (“Relativity”); and the type of content presented by the object (“Lecture Notes”). The object may therefore be identified by an annotated name including tags indicating such entity types, such as “<Class>Modern Physics</Class>-<Topic>Relativity</Topic> <Content-Type>Lecture Notes</Content-Type>.docx”. When the object is displayed for a user, the tags may be automatically removed to present the original object name. A query for a subset of objects may then be specified as a set of pairs of entity types and entity values; e.g., while a keyword-based query for “Notes” may provide results not only for this object but also for an email message with the subject line of “Notes” and an image file named “Notes” containing icon depictions of musical notes, an entity-based query may be specified as “Content-Type: Notes,” and may only receive objects where the entity value “Notes” is associated with a “Content-Type” entity type. The tags may also enable the presentation of different views of the objects of the object set, specified according to the entity types and entity values, which may provide access to the user of a desired subset of objects, irrespective of their locations in the object set. Such queries may also be correctly fulfilled if the object is relocated, even to an object system that is not configured to support the entity tagging model, and/or may be correctly utilized to fulfill queries by a device that is not configured to utilize the entity tagging model.

Automated tagging of the objects may also reduce the dependency on the user to annotate the objects; e.g., any object to which the user has assigned a name may be automatically annotated with tags without the involvement of the user, and may therefore be found in subsequent queries. Automated tagging may also automatically populate an index with a variety of information, such that an object may be discoverable through a variety of searches specifying different criteria. Such automated tagging may be onerous and/or inconsistent if performed by a user, particularly to a large object set, but an automated tagging technique may comprehensively and consistently identify such metadata and populate the index to facilitate the discoverability of the objects of the object set. In these and other ways, the annotation of the name of the object with entity tagging may enable more accurate and robust fulfillment of object queries in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring a naming of objects in an object set.

FIG. 2 is an illustration of an example scenario featuring a naming of objects in an object set in accordance with the techniques presented herein.

FIG. 3 is a component block diagram of example systems that facilitate a naming of objects in an object set, in accordance with the techniques presented herein.

FIG. 4 is a flow diagram of an example method of representing objects in an object system, in accordance with the techniques presented herein.

FIG. 5 is a flow diagram of an example method of fulfilling a query over objects in an object system, in accordance with the techniques presented herein.

FIG. 6 is an illustration of an example computer-readable medium comprising processor-executable instructions configured to embody one or more of the provisions set forth herein.

FIG. 7 is an illustration of example adaptive techniques that may be used to achieve an automated annotation of the names of objects in an object system, in accordance with the techniques presented herein.

FIG. 8 is an illustration of an example computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

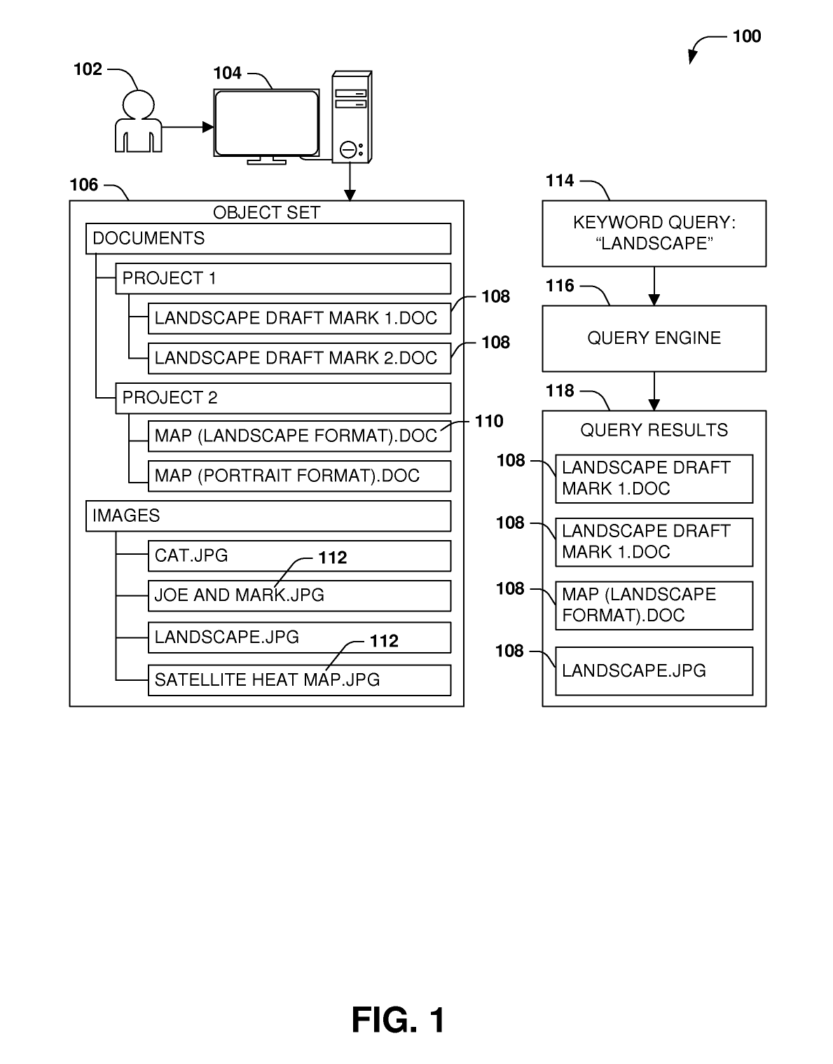

FIG. 1 is an illustration of an example scenario 100 featuring a naming of objects 108 in an object set 106. In this example scenario 100, a user 102 of a device 104 organizes an object set 106 containing objects 108 that represent files that are of interest to the user 102, such as documents comprising maps and reports and images of various people and places. The respective objects 108 have an object type 110 that is represented as an extension of the filename, such as a document format type for objects 108 of a document type, and an image format type for objects 108 that represent images 112. The user 102 may also assign descriptive names to the objects 108 that identify the object types and subject matter represented thereby.

To assist with locating objects 108 within the object set 106, the user 102 may organize the objects 108 in various ways. As a first such example, the user 102 may create a set of folders that organize objects 108 with similar properties. As a first such example, the user 102 may create a folder for objects 108 that are related to a particular project, and may place all of the objects 108 related to the project in the same folder. As a second such example, the user 102 may create folders for objects 102 that have similar subject matter, such as images of a particular person or people, and may place all objects 108 of the same person or people in the same folder. As a third such example, the user 102 may create folders for different object types 110, such as a folder for all objects 108 comprising images, and may place all objects 108 of the same object type 110 in the same folder. In this manner, the user 102 may seek to organize the objects 108 through a hierarchical structure of the object set 106. However, organizing the objects 108 according to an organizational structure may exhibit some deficiencies, where respective objects 108 are only assigned to a single location within the object set 106. For example, an object 108 may belong to a particular project that is represented by a first folder; may feature subject matter relating to a particular topic that is represented by a second folder; and may be of an object type 110 that is associated with a third folder. If the object 108 may only be located in a one location, the user 102 may have to choose arbitrarily the folder in which the object 108 is located, and may later fail to find the object 108 when looking in one of the other folders.

To address this deficiency, alternatively or additionally to organizing the objects 108 according to the hierarchical structure of the object set 106, the user 102 may utilize the names 112 of the objects 108. For example, for objects 108 representing images, the user 102 may assign names 112 to the objects 108 that describe the contents of the images, and may utilize such naming to assist with locating the objects 108. The names 112 may also include metadata about the object (e.g., that an object 108 of an image object type 112 is an image of a particular person or image type, such as a satellite heat map); format (e.g., that an object 108 of an image object type 112 is in a portrait or landscape format); and/or status (e.g., that an object 108 of a document object type 112 is a draft version of a document). Moreover, rather than browsing the object set 106 to find a desired object 108, the user 102 may utilize keyword-based searching applicable to the names 112 of the objects 108. For example, while seeking documents about a particular landscape project, the user 102 may submit a keyword query 114 containing the keyword “landscape.” The device 104 may process the keyword query 114 with a query engine 116 that compares the keywords with the names 112 of the objects 108, and may identify objects 108 that satisfy the keyword query 114 for presentation as a set of query results 118. The device 104 may present the query results 118 to the user 102, who may select one or more query results 108 for further viewing, editing, copying, transmission to another device 104, or other desirable interaction.

However, as illustrated in the example scenario 100 of FIG. 1, the application of the keyword query 114 to the names 112 of the objects 108 in the object set 106 may lead to undesirable results. For example, the keyword “landscape” may identify objects 108 with names 112 that reflect an association with the landscaping project in which the user 102 is interested, but may also contain objects 108 with names 112 that reflect the subject matter of the object 112 (e.g., generic photos of landscapes that are unrelated to the landscaping project), and objects 108 with names 112 that reflect the landscape-based format of the contents of the object 108. This conflation of the meaning of the keyword “landscape” results in the presentation of undesirable query results 118 in response to the keyword query 114. As another example, the user 102 may submit a keyword query 114 for objects 108 featuring names 112 that are associated with a particular individual named Mark, but a keyword query 114 may present query results 118 that include undesirable objects 108 with names 112 such as “mark 1” and “mark 2” that refer to various versions of a document.

The difficulties presented in the example scenario 100 of FIG. 1 relate to the ambiguity of keywords presented in the keyword query 114 that is applied to the names 112 of the objects 108. Various techniques may be utilized to refine the processing of the keyword query 114 to provide a more set of query results 118 that more accurately reflects the intent of the user 102. As a first such example, the user 102 may create a set of “tags” that represent various topics (e.g., a first tag for objects 108 that are associated with a particular project, and a second tag for objects 108 that contain subject matter relating to a particular individual), may attack such tags to each object 108, and may later search by tags instead of name-based keywords. As a second such example, the device 104 may perform an automated evaluation of the objects 108, may infer the topics and descriptors that are associated with each object 108, and may automatically seek to clarify the intent of the user 102 when submitting a keyword query 114 (e.g., when the user 102 submits a query 102 including the term “landscape,” the device 104 may determine that different types of objects 108 may relate to the query keyword in different ways, such as the format, content, and context of the object 108, and may group the query results 118 accordingly and/or ask the user 102 to clarify the context of the keyword query 114).

However, in such scenarios, it may be desirable to store such determinations in advance of the processing of the keyword query 114, as the object set 107 may be too large to perform a detailed comparison of the keyword query 114 with the contents of the individual objects 108 in order to fulfill the keyword query 114 in a timely manner. The device 104 may store such determinations in a metadata structure, such as a database or cache. Such metadata may be stored as a descriptor of the object set 106; within the object set 106 (e.g., as a separate database object 108); and/or outside of the object set 106. Further difficulties may arise if objects 108 are moved within or out of the object set 106, such that the metadata for an object 108 may no longer be available. For example, the user 102 may transmit an object 108 from the device 104 to a second device 104, but the device 104 may not include the metadata 108 for that particular object 108, and so the contextual metadata of the object 108 may be lost. Moreover, if the device 104 or a second device is not particularly configured to support the association of such metadata with the objects 108, the device 104 may be unable to use such information to inform the fulfillment of the keyword query 114 of the user 102. Many such problems may arise in the association of metadata with the objects 108 of the object set 106 in the context of evaluating the keyword query 114 of the user 102 as in the example scenario 100 of FIG. 1.

### B. PRESENTED TECHNIQUES

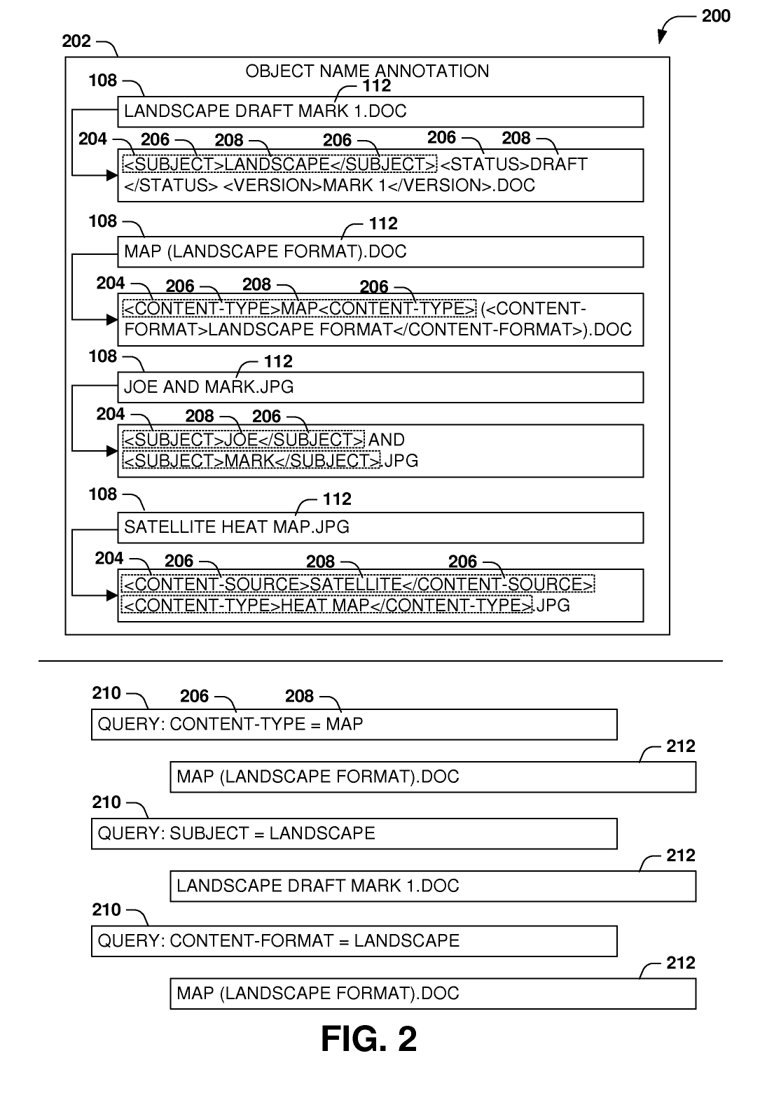

FIG. 2 presents an illustration of an example scenario 200 featuring a naming of objects in an object set in accordance with the techniques presented herein. In this example scenario 200, the respective objects 108 have a name 112 that is assigned by the user 102, and an object name annotation 202 is performed to annotate the respective names 112 with tags 204 that provide semantic metadata for the contents of the name 108 of the object 108. In particular, the tags 204 are used to identify, in the name 108 of the object 108, entity values 208 that are of a respective entity type 206. For example, for a first object 108 featuring the name 112 “Landscape Draft Mark 1.doc,” the name 112 may be evaluated to identify three entity values 208 and corresponding entity types 206: the term “landscape” indicating the subject matter of the object 108; the term “draft” indicating the status of the object 108; and the term “mark 1” indicating the version of the object 108. By contrast, the name 112 of a second object 108 may also include the term “landscape,” but as part of the entity value 208 “landscape format” that indicates the format of the contents of the object 108. These entity values 208 exist in the name 112 of the object 108, but a contextually agnostic application of a keyword query 114 to the names 112 of the objects 108 may conflate the entity values 208 of different entity types 206. In accordance with the techniques presented herein, the names 112 of the objects 108 may be annotated with tags 204 that indicate, for respective entity values 208 present in the name 108, the entity type 204 of the entity value 208. For example, the entity value 208 “landscape” that refers to the subject of the object 108 may be annotated with a tag 204 that identifies the entity value 208 as of the entity type 206 “subject,” while the entity value 208 “landscape format” that refers to the format of the object 108 may be annotated with a tag 204 that identifies the entity value 208 as of the entity type 206 “content-format.” The respective objects 108 may thereafter be represented in the object set 106 according to the annotated name 112 that includes tags 204 identifying the entity types 206 of the respective entity values 208.

The annotation of the names 112 of the objects 108 may facilitate the user 102 in locating objects 108 of interest in the object set 106. For example, the user 102 may submit a query 210 that requests objects 108 according to a pair of an entity type 206 and an entity value 208. A device 104 may process the query 210 by identifying objects 108 with annotated names 114 that include the pair of the entity type 206 and the entity value 208, and providing as query results 118 only the objects 108 with annotated names 112 that match the specified entity type 206/entity value 208 pair. For example, the user 102 may submit a first query 210 for objects 108 with the entity value 208 “map” for the entity type 206 “content-type,” and the device 104 may return only the object 108 with an annotated name 112 containing the tag 204 “<content-type>Map</content-type>”, and excluding objects 108 with names 112 that include the entity type 208 “map” but for other entity types 206. In this manner, the device 104 may utilize name annotation to include semantic metadata about the entity values 208 included in the name 112 of the object 108 in accordance with the techniques presented herein.

### C. TECHNICAL EFFECTS

The use of the techniques presented herein to represent the objects 108 of an object set 106 according to name annotation with the entity types 206 of entity values 208 may, in some embodiments, result in a variety of technical effects.

As a first example of a technical effect that may be achievable by the techniques presented herein, the annotation of names 112 of objects 108 in the manner presented herein may enable the fulfillment of queries over the object set 106 in a manner that accurately reflects the intent of the user 102. For example, the user 102 may submit queries that specify a pair of an entity type 206 and an entity value 208, and the device 104 may present only the objects 108 with annotated names 112 that include the pair of the entity type 206 and entity value 208. Alternatively, the user 102 may submit a query containing a keyword representing an entity value 208, and upon discovering that the entity value 208 is associated with at least two entity types 206 among the objects 108 of the object set 106, the device 104 may prompt the user to select or specify the intended entity type 206 for the entity value 208 that the user 102 intended by the keyword, and may use the selected entity type 206 to fulfill the query. The tagging of objects 108 in the manner presented herein may enable the user 102 to request different types of views, such as a first view of the objects 108 of the object set 106 having at least one tag 204 for a particular entity type 206, and a second view of the objects 108 of the object set 106 having at least one tag 204 indicating a selected entity value 208 for a specified entity type 206. The views may present different cross-sections of the object set 106 based on such criteria, irrespective of extraneous information such as the locations of the objects 108 in the object set 106.

As a second example of a technical effect that may be achievable by the techniques presented herein, the annotation of names 112 of objects 108 in the manner presented herein may enable the encoding of semantic information about objects 108 that only utilizes existing resources of the device 104. For example, encoding entity types 206 for respective entity values 208 in tags 204 embedded in the names 112 of the respective objects 108 does not depend upon the creation, maintenance, and/or use of a separate database provided within or outside of the object set 106, or upon any special configuration of a file system or object hierarchy. Rather, such encoding enables the storage of information according to the ordinary naming conventions of the object set 106, and may therefore be implemented through any device 104 that permits the assignment of arbitrary names 112 to objects 108 of the object set 106. Moreover, such encoding may be applied to the objects 108 of the object set 106 with a reduced dependency upon the input of the user 102; e.g., any object 108 to which the user 102 has assigned a name 112 may be automatically annotated with tags 204 indicating the entity types 206 of the entity values 208 in the name 112 without involving the input of the user 102. Such annotation may therefore be consistently applied to the objects 108 of the object set 106, while reducing a dependency on user input to achieve the tagging of the objects 108. A user may also adjust the annotation of the names 112 of the objects 108, such as by toggling the annotation on or off for an object set such as a file system, or may be limited in particular ways, e.g., applied only to objects of a particular type; applied only to objects in a particular location such as a subset of an object hierarchy; applied only to objects owned or created by a particular user; or applying only a particular subset of tags, such as only identifying entity values for entity types that are associated with the names of people.

As a third example of a technical effect that may be achievable by the techniques presented herein, the annotation of names 112 of objects 108 in the manner presented herein may facilitate the persistence and/or portability of the semantic metadata that is represented by the entity types 206 encoded in the annotated names 112 of the objects 108. As a first example, when objects 108 are relocated within or outside of the object set 106, the objects 108 retain the annotated names 112, and therefore the tags 204 encoded therein, without having to update other containers of metadata, such as other portions of a file system or a metadata database stored inside or outside of the object set 106. As a second example, objects 108 may be transmitted through other object sets 106 that do not include native support for annotated names 112, but the retention of the annotated names 112 of the objects 108 enables a retention of the tags 204 and metadata encoded thereby, such that a retransmission of the objects 108 and annotated names 112 back to the device 104 may enable the further evaluation of queries based on the annotated names 112 without loss of the metadata indicating the entity types 206 of the entity values 208 encoded thereby.

As a fourth example of a technical effect that may be achievable by the techniques presented herein, the annotation of names 112 of objects 108 in the manner presented herein may enable a selective removal and/or disregard of the tags 204. That is, the format of the tags 204 encoded in the names 112 of the objects 108 may be selected such that a device 104 may automatically remove the tags 204 when presenting the name 112 of the object 108 to the user 102. For example, as illustrated in the example scenario 200 of FIG. 2, an extensible markup language (XML) tag syntax may be utilized that represents tags 204 as an opening tag and a closing tag that are both offset by angle brackets, and when the name 112 of the object 108 is displayed to the user 102, all angle-bracket-delineated tags 204 may be automatically removed. Other formats of the tags 204 included in the names 112 of the objects 108 may also be utilized, such as a variant of JavaScript Object Notation (JSON), a markup style such as a Rich Document Format (RDF), or a tuple-based document format such as key/value pairing. Such tagging may also present a format that is familiar to and readily understandable by developers, and may be readily applied by developers in the development of contextually-aware applications and interfaces. Many such technical effects may be exhibited by various embodiments of the techniques presented herein.

### D. EXAMPLE EMBODIMENTS

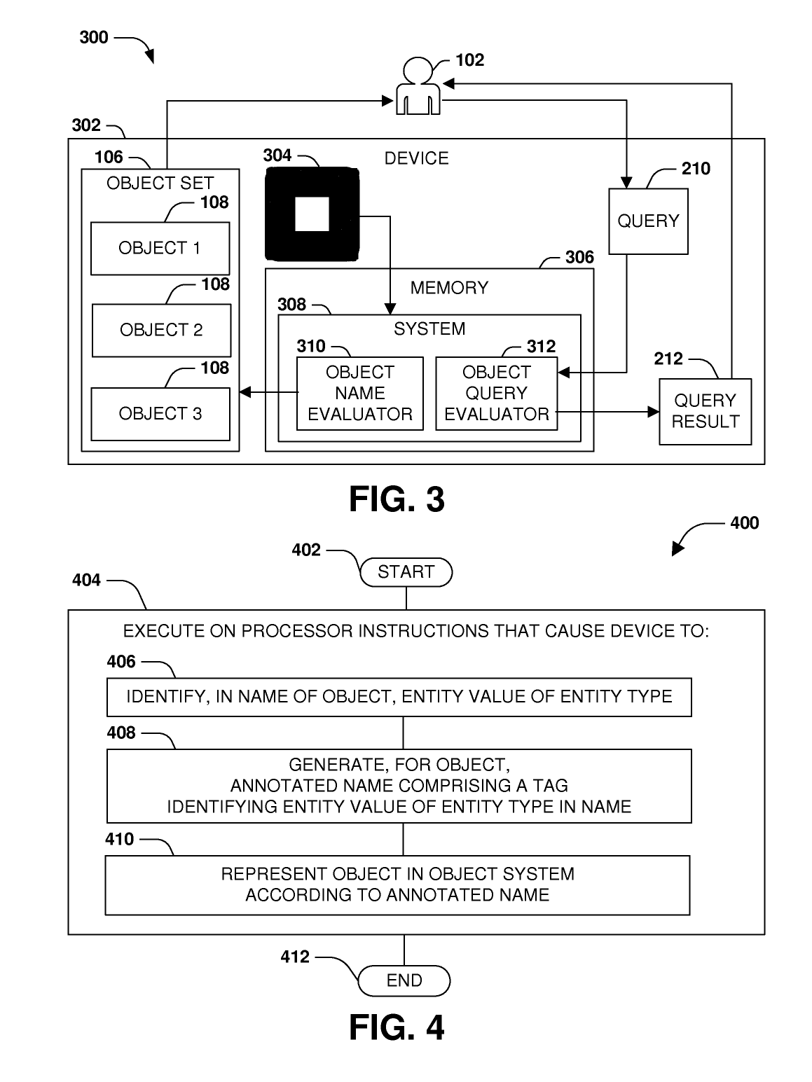

FIG. 3 presents a first example embodiment of the techniques presented herein, illustrated as an example system 308 encoded within an example device 302 that fulfills a query 208 of a user 102 over the objects 108 of an object set 106 in accordance with the techniques presented herein. The example system 308 may be implemented, e.g., on an example device 302 having a processor 304 and an object set 106 of objects 108 respectively having a name 112. Respective components of the example system 308 may be implemented, e.g., as a set of instructions stored in a memory 306 of the example device 302 and executable on the processor 304 of the example device 302, such that the interoperation of the components causes the example device 302 to operate according to the techniques presented herein.

The example system 308 comprises an object name evaluator 310, which identifies, in a name of the respective objects 108 of the object set 106, an entity value 208 of an entity type 206, and annotates the name 112 of the object 108 in the object set 106 with a tag 204 identifying the entity type 206 of the entity value 208 in the name 112. The example system 308 further comprises an object query evaluator 312, which fulfills a query 210 requesting objects 108 of the object set 106 associated with a selected entity type 208, by determining whether, for respective objects 108 of the object set 106, the entity type 206 of the tag 204 of the annotated name 112 of the object 108 matches the selected entity type 206 of the query 212; and responsive to determining that the entity type 206 matches the selected entity type 206, presents the object 108 as a query result 118 of the query 210. In this manner, the example device 302 may operate to fulfill the query 210 of the user 102 in accordance with the techniques presented herein.

FIG. 4 presents a second example embodiment of the techniques presented herein, illustrated as an example method 400 of representing an object 108 in an object set 106. The example method 400 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 400 begins at 402 and involves executing 404 the instructions on a processor of the device. Specifically, executing 404 the instructions on the processor causes the device to identify 406, in the name 112 of the object 108, an entity value 208 of an entity type 206. Executing 404 the instructions on the processor also causes the device to generate 408, for the object 108, an annotated name 112 comprising a tag 204 identifying the entity type 206 of the entity value 208 in the name 112. Executing 404 the instructions on the processor also causes the device to represent 410 the object 108 in the object set 106 according to the name 112 annotated with the tag 204. In this manner, the example method 400 achieves the representation of the object 108 in the object set 106 according to the techniques presented herein, and so ends at 412.

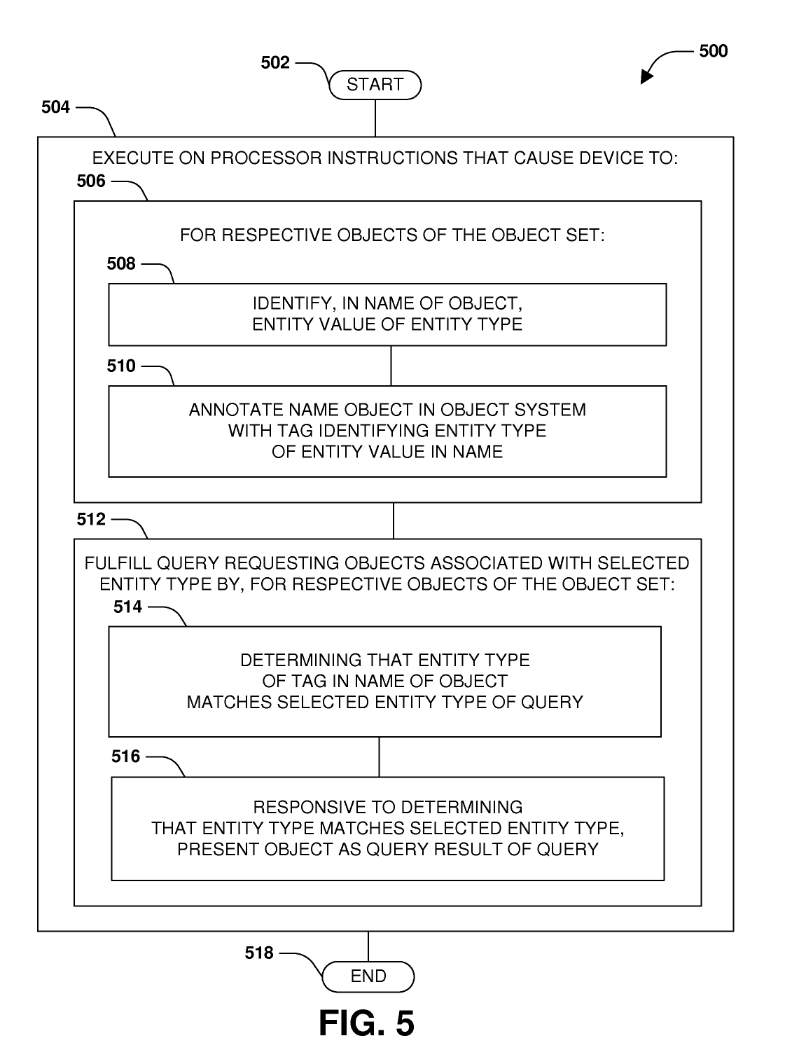

FIG. 5 presents a second example embodiment of the techniques presented herein, illustrated as an example method 500 of fulfilling a query 210 of an object set 106. The example method 400 may be implemented, e.g., as a set of instructions stored in a memory component of a device, such as a memory circuit, a platter of a hard disk drive, a solid-state storage device, or a magnetic or optical disc, and organized such that, when executed on a processor of the device, cause the device to operate according to the techniques presented herein.

The example method 500 begins at 502 and involves executing 504 the instructions on a processor of the device. Specifically, executing 504 the instructions on the processor causes the device to, for the respective 506 objects 108 of the object set 106, identify 508, in the name 112 of the object 108, an entity value 208 of an entity type 206; and annotate 510 the name 112 of the object 10 in the object set 106 with a tag 204 identifying the entity type 206 of the entity value 208 in the name 112. Executing 504 the instructions on the processor causes the device to fulfill a query 210 requesting objects 108 of the object set 106 associated with a selected entity type 206 by, for the respective 512 objects 108 of the object set 106, determining 514 whether the entity type 206 of the tag 204 of the name 112 of the object 108 matches the selected entity type 206 of the query 210; and responsive to determining 514 that the entity type 206 matches the selected entity type 206, presenting 516 the object 108 as a query result 212 of the query 210. In this manner, the example method 500 achieves the fulfillment of the query 210 over the object set 106 according to the techniques presented herein, and so ends at 518.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

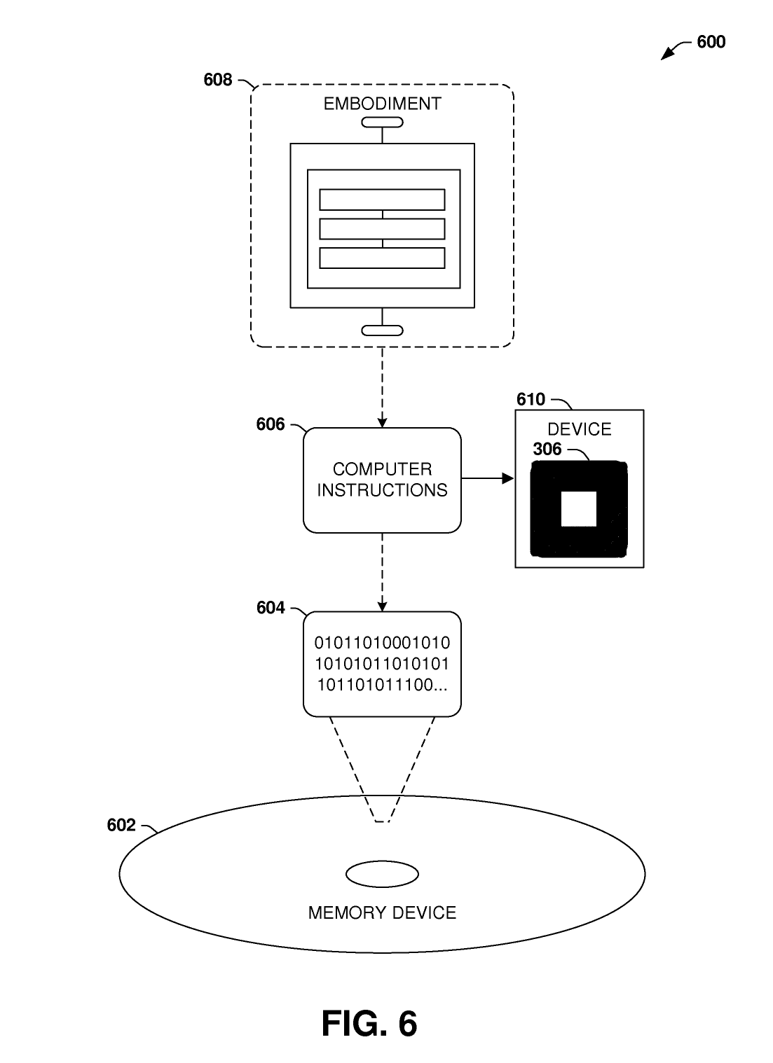

An example computer-readable medium that may be devised in these ways is illustrated in FIG. 6, wherein the implementation 600 comprises a computer-readable memory device 602 (e.g., a CD-R, DVD-R, or a platter of a hard disk drive), on which is encoded computer-readable data 604. This computer-readable data 604 in turn comprises a set of computer instructions 606 that, when executed on a processor 304 of a device, cause the device to operate according to the principles set forth herein. In a first such embodiment, the processor-executable instructions 606 may provide a system for representing objects 108 in an object set 106, such as the example system 308 in the example scenario 300 of FIG. 3. In a second such embodiment, the processor-executable instructions 606 may cause the device 610 to perform a method of representing objects 108 in an object set 106, such as the example method 400 of FIG. 4. In a third such embodiment, the processor-executable instructions 606 may cause the device 610 to fulfill a query 210 over an object set 106, such as the example method 500 of FIG. 5. Many such computer-readable media may be devised by those of ordinary skill in the art that are configured to operate in accordance with the techniques presented herein.

### E. VARIATIONS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the example system 308 of FIG. 3; the example method 400 of FIG. 4; the example method 500 of FIG. 5; and the example memory device 602 of FIG. 6) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be implemented on a wide variety of devices, such as workstations, laptops, tablets, mobile phones, game consoles, portable gaming devices, portable or non-portable media players, media display devices such as televisions, appliances, home automation devices, computing components integrated with a wearable device integrating such as an eyepiece or a watch, and supervisory control and data acquisition (SCADA) devices.

As a second variation of this first aspect, the techniques presented herein may be implemented with a wide variety of object sets 106 where respective objects 108 have names 112, such as files in a file system; resources in a resource set, such as images in an image collection; and records in a database; pages on one or more webservers. The object set 106 may also be organized in various ways, such as a hierarchical structure (e.g., a hierarchical file system); a loosely structured or grouped object set 106 (e.g., a set of objects 108 that are respectively tagged with various descriptive tags); and an unstructured object set 106, where objects 108 are named 112 but are not otherwise organized.

As a third variation of this first aspect, the techniques presented herein may be implemented to fulfill a wide variety of queries 210 and to present a wide variety of query results 212 in response thereto, such as keyword- and/or criterion-based queries, natural-language queries, and logically structured queries provided with Boolean logical connectors. Such queries may also involve queries specified in an organized language that is amenable to automated application to a data set, such as a variant of the Structured Query Language (SQL) or the XML Path Language (XPath). Many such variations in the scenarios may be devised to which the techniques presented herein may be applied.

E2. Identification of Entity Values and Entity Types

A second aspect that may vary among embodiments of the techniques presented herein involves the manner of identifying the entity values 208 and the entity types 206 thereof in the names 112 of the objects 108 of the object set 106.

As a first variation of this second aspect, the entity values 208 and entity types 206 may be specified by the user 102, such as by explicit tagging through a user interface. A device may receive, from the user 102, a selection of the entity value 208 in the name 112 of the object 108, and an identification of the entity type 206 of the entity value 208. The device may therefore annotate the name 112 of the object 108 with a tag 204 indicating the entity type 206 of the entity value 208 in the name 112 of the object 108.

As a second variation of this second aspect, the name 112 of the object 108 may be automatically processed to determine which subsets of symbols in the name 112 are likely to represent an entity value 208. For example, the name 112 may be processed to choose words that represent nouns, and to remove words that represent adjectives, adverbs, and articles, such that a name 112 of an object 108 such as “an image of a blue cat” may be identified as having entity values 208 of “image” and “cat.” Such automated processing may also be applied to identify possible partitions of entity values 208, such as whether the phrase “landscape map” in the name 112 of an object 108 refers to a first entity value 208 for the term “landscape” and a second entity value 208 for the term “map,” or whether the phrase “landscape map” is determined to be a single entity value 208.

As a third variation of this second aspect, one or more objects 108 may comprise object content, such as the binary contents of a file, and an object name evaluator 310 may identify the entity value 208 of the entity type 206 by determining the entity type 206 of the entity value 208 according to the object content of the object 108. For example, if the name 112 of an object 108 includes the term “landscape,” the object name evaluator 310 may examine the contents of the object to infer whether the term “landscape” refers to a landscaping project with which the object 108 is associated; a topic described or depicted in the content of the object 108, such as an image of a landscape; or a metadata indicator of the object 108, such as a landscape format of an image. The evaluation of the content of the object 108 may enable an inference of the entity type 206 of the entity value 208 identified in the name 112 of the object 108.

As a fourth variation of this second aspect, one or more objects 108 may have an object location within the object set 108, and the object locations may be utilized to determine the entity types 206 of the entity values 208. That is, the object locations may present the names of folders within the object set 106, and the folder names and structures may inform inferences of entity values 206 of object types 208. For example, an entity value 208 of “landscape” in the name 112 of an object 108 may be inferred as having the entity type 206 of “project” if the object 108 is stored in a “Projects” folder, and as having the entity type 206 of “image-subject” if the object 108 is stored in an “Images” folder.

As a fifth variation of this second aspect, an object 108 may be utilized by a user 102 in a usage context, and the inference of the entity type 206 of an entity value 208 may be achieved according to the usage context. For example, for an object 102 having a name 112 including the term “Mark,” the entity type 206 of the entity value 208 may be determined as referring to a particular individual if the user 102 received the object 102 from and/or sends the object 102 to an individual named “Mark.”

As a sixth variation of this second aspect, a first object 108 may be associated with a second object 108 of the object set 106, where the second object 106 comprises a second object name 108 including a second object entity value 208 of a second object entity type 206. The inference of an entity type 206 of an entity value 208 in the first object 108 may be determined according to the entity type 206 and/or entity value 208 of the second object 108 with which the first object 108 is associated. For example, the name 112 of the first object 108 may include the term “Mark,” and while the first object 108 may have no metadata that indicates the semantic intent of the term “Mark,” the first object 108 may be grouped with and/or frequently used with a second object 108 having the entity value 208 “Mark” in a tag 206 including the entity type 206 “Person.” The first object 108 may therefore also be annotated with a tag 204 including the entity type 206 “Person” for the entity value 208 “Mark.”

As a seventh variation of this second aspect, inferences of the entity types 206 of the entity values 208 of the respective objects 108 may be achieved by clustering the objects of the object set according to object similarity. For example, various information about the respective objects 108 may be compared to calculate a similarity score indicating an object similarity of respective pairs of objects 108, and inferences about the entity types 206 of the entity values 208 in a first object 108 may be inferred with reference to the entity types 206 and/or entity values 208 in the name 112 of a second object 108 with which the first object 108 shares a high similarity score. For example, a first object 108 may have an entity value 208 of “Mark,” but it may be difficult to determine the entity type 206 of the entity value 208 based only on the first object 108. The first object 108 may also have a high similarity score with other objects 108 with names 112 that have been annotated, but the other objects 108 may not have any entity value 208 of “Mark.” Nevertheless, it may be determined that if many of the other objects 108 have names 112 including entity values 208 for an entity type 206 of “Person,” then the entity value 208 of “Mark” in the first object 108 likely has an entity type 206 of “Person.”

As an eight variation of this second aspect, a device may comprise a classifier that, among at least two entity types 206 of a selected entity value 208, identifies a selected entity type 206 having a highest probability for the entity value 208 among the at least two entity types 206. For example, if the name 112 of an object 108 includes an entity value 208 of “Mark” that may be either the name of a person or a version identifier, the classifier may have been trained to determine that the entity value 208 is more likely to represent a name (and is therefore of entity type 206 “Person”) if it is capitalized and/or followed by a capitalized word representing a last name, and more likely to represent a version identifier (and is therefore of entity type 206 “Version”) if it is lowercase and/or followed by an integer, decimal number, letter, date, or other typical type of version identifier. The device may therefore determine the entity types 206 of the entity values 208 in the name 112 of an object 108 by invoking the classifier with the respective entity values 208.

As a ninth variation of this second aspect, a device may comprise an entity type schema that specifies acceptable and/or frequently utilized entity types 206 and/or entity values 208 thereof. An entity type schema may be utilized in a mandatory manner (e.g., entity types 206 are only selected that appear in the entity type schema; entity values 208 may only be included in the name 112 of an object 108 if the entity type schema validates the entity value 208 for a particular entity type 206, such as limiting the object values 208 of “People” to entries in a contact directory), such that names 112, entity types 206, and/or entity values 208 may only be accepted that conform with the entity type schema. Alternatively, the entity type schema may be utilized in an optional and/or assistive manner, e.g., to inform the inference of object types 206 of object values 208 according to frequent usage, and/or to suggest to a user 102 an entity type 206 that is frequently attributed to a particular entity value 208.

As a tenth variation of this second aspect, the determination of entity types 206 and/or entity values 208 may be performed according to the detection of user metadata about the user 102 from according to a user profile, which may inform the detection of entity values 208 and/or the determination of the entity types 206. For example, a social user profile of the user 102 may specify the names of other individuals with whom the user 102 is associated, including the proper names, nicknames, and relative identifiers such as “brother” and “coworker.” A device may compare the names of such individuals with tokens in the names 112 of the respective objects 108. A detected match may lead to an identification of the entity values 208 in the name 112 of the object 108 (e.g., determining that the keyword “Mark” in the name 112 identifies a related individual), and/or to determine the entity types 206 of the entity values 208 (e.g., determining that the keyword “Fido” refers to the name of a pet animal).

As an eleventh variation of this second aspect, a device may monitor activities of the user 102 to determine entity types 206 and/or entity values 208 in objects 108 of the object set 106. Such activities may involve, e.g., activities of the user 102 in the real world that are detected by a physical sensor, such as a camera, gyroscope, or global positioning system (GPS) receiver, and/or activities of the user 102 within a computing environment that are detected by a device, such as messages exchanged over a network or the accessing of objects 108 within the object set 106. As a first such example, the location of the user 102 may be monitored to determine the location where an object 108 (such as a photo) was created, modified, or accessed, and the name of the location may be determined and compared with tokens of the name 112 of the object 108 to identify entity types 206 and/or entity values 208 (e.g., determining that the word “Park” in the name 112 of the object 108 refers to a location, because the user 102 was located in a nature reserve when the object 108 was created). Such data may also facilitate disambiguation of entity values 208, such as determining whether the term “Mercury” refers to the planet or the element. As a second such example, the actions of the user 102 may be evaluated to inform the detection of entity values 208 and/or the determination of entity types 206; e.g., if the user 102 is detected to be reading a particular book, an object 108 comprising a description of a narrative work that shares part of the title of the book may be tagged accordingly.

As a twelfth variation of this second aspect, a variety of computational techniques may be utilized to perform the detection of the entity values 208 and/or determination of entity types 206 in the name 112 of an object 108, based on a collection of data gathered from a variety of sources. Such techniques may include, e.g., statistical classification, such as a Bayesian classifier, may be utilized to determine whether a particular keyword or token corresponds to an entity type 208 and/or indicates the entity value 206 thereof. Alternatively or additionally, such techniques may include, e.g., an artificial neural network that has been trained to determine whether a token or keyword in a name 112 corresponds to an entity value 208 and/or an entity type 206 thereof. An artificial neural network may be advantageous, e.g., due to its ability to attribute weights to various inputs that may otherwise lead to incorrect or conflicting results; e.g., the identification of entity values 208 based on detected activities of the user may be determined to be more accurate than information derived from a user profile, particularly if the user profile is out of date.

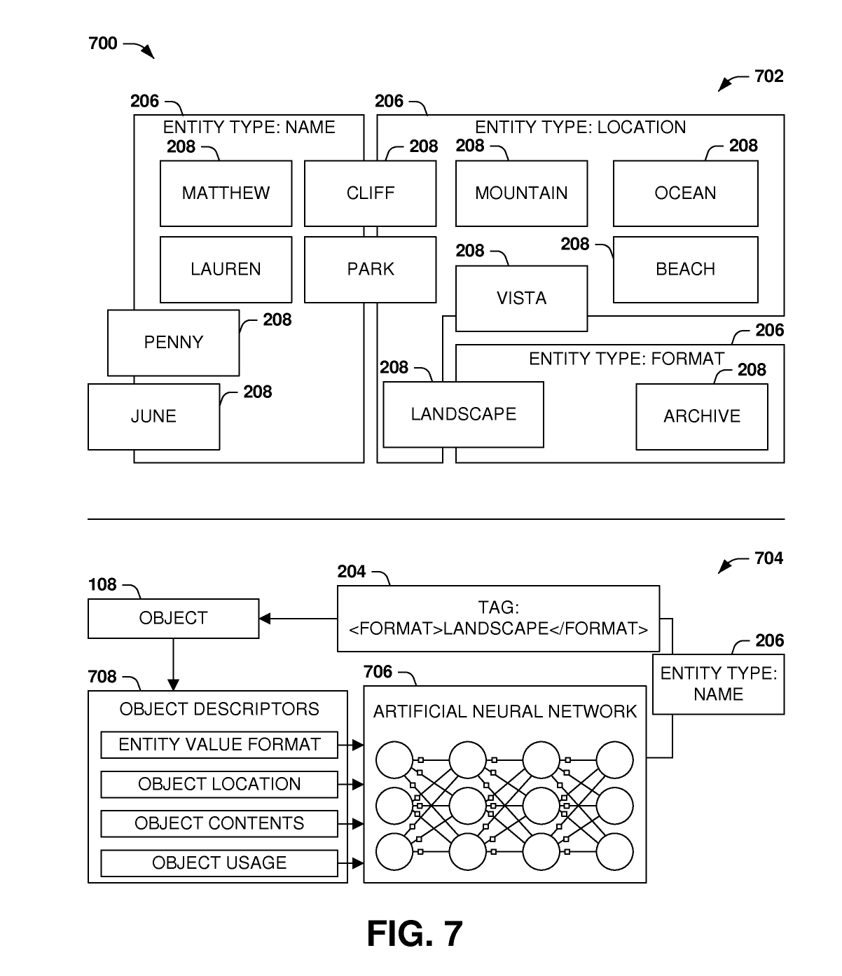

FIG. 7 presents an illustration 700 of example techniques that may be used to achieve the automated determination of the entity types 206 and/or entity values 208 in accordance with the techniques presented herein. As a first such example 702, a clustering technique may be utilized to associate respective entity values 208 with one or more entity types 206, such as the frequency and/or probability with which a particular entity value 208 is associated with respective entity types 206. For example, the names “Matthew” and “Lauren” are associated primarily with the entity value 208 of a person's name, while the words “Mountain” and “Ocean” are associated primarily with the entity value 206 of a location. However, an entity value 208 such as “Cliff” may be either the name of a person or the name of a location, and may be associated with both entity types 206. When an object 108 features a name 112 that includes such an entity value 208, a disambiguation may be performed according to the other entity types 206 that are present in the name 112 of the object; e.g., an object named “Matthew, Lauren, and Cliff” may be interpreted as presenting a set of entity values 208 with the entity type 206 of an individual name, while an object named “Oceans and Cliffs” may be interpreted as presenting a set of entity values 208 with the entity type 206 of locations.

As a second such example 704, an adaptive algorithm such as an artificial neural network 706 may be utilized to identify the entity types 206 of various entity values 208. In this second example 704, an object 108 with a name 112 featuring an entity value 208 may be associated with a set of object descriptors 708 that inform a determination of the entity type 206 of the entity value 208. As a first such example, the object 108 may include an entity value 208 of a particular format; e.g., words that are capitalized are more likely to present names, while entity values 208 that are not capitalized are less likely to present names. As a second such example, the object location of the object 108 in the object set may be informative; e.g., if an object 108 is placed in a folder called “People,” and entity values 208 in the name 112 of the object 108 may be more likely to represent the names of people. As a third such example, the contents of the object may be informative; e.g., if an object 108 comprising a photo has a name 112 featuring a word such as “cliff” refers to a person named Cliff or a location, the entity value 206 may be determined by evaluating the contents of the image. As a fourth such example, the usage of the object 108 may be informative; e.g., an object 108 with a name featuring the entity value 208 “cliff” may be disambiguated by identifying an email attaching the object and delivered to an individual named Cliff. Moreover, in some contexts, the object descriptors 708 may suggest contradictory entity types 206; e.g., an object may be delivered to a person named “Cliff” but may contain a picture of a cliff. Disambiguation may be achieved by providing the object descriptors 708 to an artificial neural network 706 that has been trained to identify the entity type 206 of a particular entity value 208, and the output of the artificial neural network 206 may correctly determine that a particular entity value 208 is likely associated with a particular entity type 206. The entity type 206 may then be encoded in a tag 204 embedded in the name 112 of the object 108 in accordance with the techniques presented herein.

As a thirteenth variation of this second aspect, the determination of entity types 206 and/or entity values 208 in the names of the objects 108 may be timed in various ways. As a first such example, the techniques presented herein may be utilized when a name 112 is assigned to an object 108, and may result in a static or one-time assessment of the name 112. As a second such example, the techniques presented herein may be invoked in response to an action or indicator that prompts a reevaluation of the name 12 of a selected object 108, such as when the user 102 renames the object 108, accesses the object 108, or performs an activity that involves the object 108, such as communicating with an individual that is associated with a particular object 108. As a third such example, the techniques presented herein may be reapplied to reevaluate the object set 106 (e.g., periodically, or upon receiving additional information that may alter a previous evaluation of an object 108, such as the receipt of a user profile of the user 102 or an update thereto). Many such variations in the identification of entity values 208 and entity types thereof 206, and the computational techniques utilized to achieve such identification, may be included in variations of the techniques presented herein.

E3. Name Annotation

A third aspect that may vary among embodiments of the techniques presented herein involves the manner of annotating the name 112 of an object 108 with tags 204 identifying the entity types 206 of the entity values 208 included therein.

As a first variation of this third aspect, the tags 204 may be specified in various formats and/or in accordance with various conventions. As a first such example, in the example scenario 200 of FIG. 2, the tags 204 are specified according to a familiar XML syntax, where entity values 208 are enclosed by an opening tag and a closing tag, each indicated by angle brackets and specifying a name or identifier of the entity type 206. As a second such example, the annotation of the entity types 206 for the entity values 208 in the name 112 of the object 108 may be achieved in a one-to-one manner; i.e., each entity value 208 may be assigned to one entity type 206. Alternatively, one entity type 206 may include several entity values 208, such as in a comma-delimited list or in a hierarchical tag structure, and/or one entity value 208 may be associated with multiple entity types 206, such as the entity value “Landscape” 208 in the name 112 of an object 108 indicating both the name of a project (e.g., a landscaping project) and the subject of an image included in the object 108 (e.g., a landscape-formatted image of the landscaping project).

As a second variation of this third aspect, upon generating an annotated name 112 of an object 108, a device may substitute the annotated name 112 of the object 108 for the unannotated name 112 of the object 108. Alternatively, the device may store the annotated name 112 alongside the unannotated name 112 of the object 108, and may variously use the annotated name 112 and the unannotated name 112 in different contexts (e.g., using the annotated name 112 for searching and canonical identification, and using the unannotated name when presented to the user 102, thus refrain from presenting tag 204 indicating the entity types 206 while presenting the object set 106 to the user 102). Such unannotated presentation may also be achieved by automatically removing tags 204 from the annotated name 112 while presenting the object 108 to the user 102.

As a third variation of this third aspect, responsive to receiving a request to relocate an object 108 within the object set 106 from an initial location of the object 108 to a second location, a device may update the annotated name 112 of the object 108 to reflect the second location within the object set 106, while persisting the tag 204 identifying the entity type 206 of the entity name 208 within the annotated name 112 of the object 108. For example, if the user 102 moves an object 108 to a folder containing objects 108 for a particular project, the device may insert into the name 112 of the object 108 an entity type 206 of “Project” and entity value 208 identifying the project. The object 108 may therefore retain this association, as part of the name 112 of the object 108, even if the object 108 is later moved out of the folder. Conversely, a tag 204 that is associated with an initial location of the object 108, and that is not associated with the second location, may be persisted by persisting the tag 204 associated with the initial location of the object 108 in the annotated name 112 of the object 108 (e.g., retaining the identifier of the project as an entity value 208 of the entity type 206 “Project” in the name 112 of the object 108, even after the object 108 is moved out of the folder for the project).

As a fourth variation of this third aspect, the name 112 of an object 108 may be annotated by identifying a source of information about the entity value 208 of the entity type 206, and storing, within the tag 204, a reference to the source of information about the entity value 208 of the entity type 206 of the tag 204. For example, for a tag 204 indicating that an object 108 is associated with an entity type 206 of “Person,” the tag 204 may include a reference to a contact identifier for the person identified by the object value 208, or a uniform resource identifier (URI) of a web resource that further describes the object 108 and/or from which the object 108 was retrieved. The reference may be presented to the user 102, e.g. as a hyperlink, which may assist the user 102 with retrieving information that is associated with the object 108. Accordingly, responsive to receiving a request for information about the entity value 208 specified in the name 112 of an object 108, a device may retrieve, from the source identified in the tag 204, information about the entity value 208, and present the information retrieved from the source to the user 102. Many such variations may be devised for the annotation of the name 112 of the object 108 in accordance with the techniques presented herein.

E4. Query Fulfillment

A fourth aspect that may vary among embodiments of the techniques presented herein involves the fulfillment of queries over an object set 106 using the tags 204 indicating the entity types 206 of the entity values 208 within the names 112 of the objects 108.

As a first variation of this fourth aspect, a device may index the objects 108 of an object set 106 according to the entity types 206 and/or the entity values 208 thereof. For example, a device may represent the objects 108 of the object set 106 by indexing the objects 108 in an index according to the entity value 208 of the entity type 206, and may identify objects 108 that satisfy a particular query 106 by examining the index of the object set 108 to identify objects having a name 112 that is annotated with a tag 204 identifying the selected entity type 206 of an entity value 208 within the name 112 of the object 108.

As a second variation of this fourth aspect, a query 210 may further specify a selected entity value 206 of a selected entity type 206, and a device may identify objects 108 that satisfy a particular query 106 by identifying objects for which the entity value 208 of the entity type 206 of the tag 204 matches the selected entity value 208 of the query 210.

As a third variation of this fourth aspect, responsive to a request from the user 102 to present the object set 106, a device may present a list of entity types 206 that are identified by the tag 204 of at least one object 108 of the object set 106, and may also withhold from the list at least one entity type 206 that is not identified by the tag 204 of at least one object 108 of the object set 106 (e.g., allowing the user 102 to browse the entity types 206 that are currently in use in the object set 106). Such browsing may be utilized, e.g., when the availability of entity types 206 and/or entity values 208 for the object set 106 is particularly large. In such scenarios, an embodiment may recommend one or more entity types 206 and/or entity values 208 to receive a view thereof; e.g., instead of presenting the names of all individuals who appear in at least one photo of a photo database, an embodiment may determine that the user 102 is currently interacting with a particular user, and may recommend a search for images that include the name of the individual as an entity value 208. Responsive to a selection of a selected entity type 206, the device may present the objects 108 that feature at least one tag 204 specifying the selected entity type 206. Alternatively or additionally, the device may present the entity values 208 of the object type 206 that are included in at least one tag 204 of at least one object 108 of the object set 106, and responsive to a selection of a selected entity value 208, ma present the objects 108 having at least one tag 240 that matches both the selected entity type 206 and the selected entity value 208.

As a fourth variation of this fourth aspect, responsive to receiving a name query for the object set 106, a device may compare the name query with both the annotated name 112 and the unannotated name 112 of respective objects 108 of the object set 106, and may present objects 108 of the object set 106 where at least one of the unannotated name 112 and the annotated name 112 of the object 108 matches the name query. Many such variations may be devised in the fulfillment of queries over the object set 106 using the tags 204 in the annotated names 112 of the objects 108 in accordance with the techniques presented herein.

### F. COMPUTING ENVIRONMENT

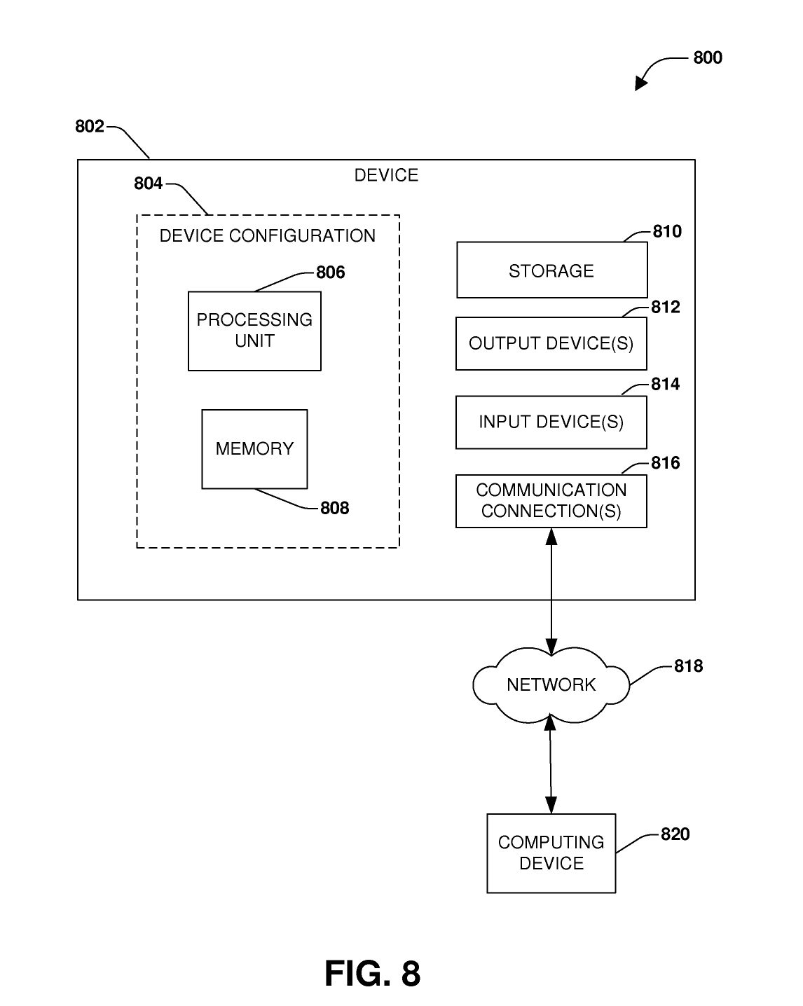

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer-readable memory devices that exclude other forms of computer-readable media comprising communications media, such as signals. Such computer-readable memory devices may be volatile and/or nonvolatile, removable and/or non-removable, and may involve various types of physical devices storing computer readable instructions or other data. Memory 808 and storage 810 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

### G. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A device comprising:
a processor; and
a memory storing:
an object set comprising at least one object; and
instructions that, when executed by the processor, provide a system that represents an object of the object set, the system comprising:
an object name evaluator that:
identifies, in a name of the object, an entity value of an entity type;
annotates the name of the object in the object set with a tag identifying the entity type of the entity value in the name; and
an object query evaluator that fulfills a query requesting objects of the object set associated with a selected entity type, by:
determining whether the entity type of the tag of the annotated name of the object matches the selected entity type of the query; and
responsive to determining that the entity type matches the selected entity type, presenting the object as a query result of the query.

2. The device of claim 1, wherein the object name evaluator identifies the entity value of the entity type by receiving, from a user:
a selection of the entity value in the name of the object; and
an identification of the entity type of the entity value.

3. The device of claim 1, wherein:
the object further comprises object content; and
the object name evaluator identifies the entity value of the entity type by determining the entity type of the entity value according to the object content of the object.

4. The device of claim 1, wherein:
the object is located at an object location within the object set; and
the object name evaluator identifies the entity value of the entity type by determining the entity type of the entity value according to the object location of the object within the object set.

5. The device of claim 1, wherein:
the object is utilized by a user in a usage context; and
the object name evaluator identifies the entity value of the entity type by determining the entity type of the entity value according to the usage context in which the user interacts with the object.

6. The device of claim 1, wherein:
the object is associated with a second object of the object set, wherein the second object is identified by a second object name further comprising a second object entity value of a second object entity type; and
the object name evaluator identifies the entity value of the entity type by determining the entity type of the entity value according to the second object entity type of the second object entity value of the second object that is associated with the object.

7. The device of claim 1, wherein:
the system further comprises an object clusterer that clusters the objects of the object set according to object similarity;
the object is clustered with a second object of the object set, wherein the second object is identified by a second object name further comprising a second object entity value of a second object entity type; and
the object name evaluator identifies the entity value of the entity type by determining the entity type of the entity value according to the second object entity type of the second object entity value of the second object that is clustered with the object.

8. The device of claim 1, wherein:
the system further comprises a classifier that, among at least two entity types of a selected entity value, identifies a selected entity type having a highest probability for the entity value among the at least two entity types; and
the object name evaluator determines the entity type of the entity value of the object by invoking the classifier with the entity value.

9. The device of claim 1, wherein:
respective entity types are selected from an entity type schema; and
the object name evaluator identifies the entity value of the entity type by selecting the entity type of the entity value from the entity type schema.

10. A method of representing an object in an object set on a device having a processor, the method comprising:
executing, on the processor, instructions that cause the device to:
identify, in a name of the object, an entity value of an entity type;
generate, for the object, an annotated name comprising a tag identifying the entity type of the entity value in the name; and
represent the object in the object set according to the annotated name.

11. The method of claim 10, wherein representing the object in the object set further comprises: while presenting the object set to the user, refrain from presenting the tag indicating the entity type in the annotated name of the object.

12. The method of claim 10, wherein executing the instructions further causes the device to, responsive to receiving a request to relocate the object within the object set from an initial location of the object to a second location, update the annotated name of the object to reflect the second location within the object set while persisting the tag identifying the entity type of the entity name within the annotated name of the object.

13. The method of claim 12, wherein:
the tag is associated with the initial location of the object, and is not associated with the second location; and
persisting the tag further comprises: persisting the tag associated with the initial location of the object in the annotated name of the object.

14. The method of claim 10, wherein generating the annotated name further comprises:
identifying a source of information about the entity value of the entity type; and
storing, within the tag, a reference to the source of information about the entity value of the entity type of the tag.

15. The method of claim 14, wherein executing the instructions further causes the device to, responsive to receiving a request for information about the entity value:
retrieve, from the source identified in the tag, information about the entity value; and
present the information retrieved from the source to the user.

16. A method of fulfilling a query of an object set on a device having a processor, the method comprising:
executing, on the processor, instructions that cause the device to:
for respective objects of the object set:
identify, in a name of the object, an entity value of an entity type; and
annotate the name of the object in the object set with a tag identifying the entity type of the entity value in the name; and
fulfill a query requesting objects of the object set associated with a selected entity type by:
determining whether the entity type of the tag in the name of the object matches the selected entity type of the query; and
responsive to determining that the entity type matches the selected entity type, presenting the object as a query result of the query.

17. The method of claim 16, wherein:
representing the object in the object set further comprises: in an index of the object set, index the object according to the entity value of the entity type; and
determining that the entity type of the tag matches the selected entity further comprises: examining the index of the object set to identify, within the object set, at least one object having a name annotated with a tag identifying the selected entity type of an entity value within the name of the object.

18. The method of claim 16, wherein:
the query further specifies a selected entity value of the selected entity type; and
determining that the entity type of the tag matches the selected entity type further comprises: determining that the entity value of the entity type of the tag matches the selected entity value of the query.

19. The method of claim 16, wherein executing the instructions further causes the device to, responsive to a request to present the object set:
present a list of entity types that are identified by the tag of at least one object of the object set; and
withholding from the list at least one entity type that is not identified by the tag of at least one object of the object set.

20. The method of claim 16, wherein executing the instructions further causes the device to, responsive to receiving a name query for the object set:
compare the name query with the name and an unannotated name of respective objects of the object set; and
present objects of the object set where at least one of the unannotated name and the annotated name of the object matches the name query.
